(19) United States
(12) Patent Application Publication
(10) Pub. No.: US 2024/0113535 A1
(43) Pub. Date: Apr. 4, 2024

(54) HYBRID BATTERY PLATE

(71) Applicant: Jared Cohn, Sherman Oaks, CA (US)

(72) Inventor: Jared Cohn, Sherman Oaks, CA (US)

(21) Appl. No.: 18/061,425

(22) Filed: Dec. 2, 2022

Related U.S. Application Data
(60) Provisional application No. 63/378,042, filed on Sep. 30, 2022.

(51) Int. Cl. H02J 7/00; H01M 10/44

(52) U.S. Cl. CPC H02J 7/0042; H01M 10/44

(57) ABSTRACT

A hybrid battery plate capable of non-concurrently receiving a first-type battery and a second-type battery. In a first configuration, the hybrid battery place may receive the first-type battery but not the second-type battery. In a second configuration, the hybrid battery plate may receive the second-type battery but not the first-type battery. The hybrid battery plate may comprise a first-type battery receiving element movably secured within a cavity in a battery plate body. The first-type battery may be a v-mount battery and the second-type battery may be a gold-mount battery.

### CROSS-REFERENCE TO RELATED APPLICATIONS

This application claims the benefit of U.S. provisional patent application No. 63/378,042 filed on Sep. 30, 2022, the content of which is incorporated by reference in its entirety.

### BACKGROUND

### Field of the Invention

The present invention relates generally to battery plates, and, in particular, to battery plates capable of receiving multiple battery types.

### Scope of the Prior Art

In the filmmaking profession, many lights, cameras, and camera accessories are powered by bulky, high-capacity batteries. V-mount batteries and gold-mount batteries are two such examples.

FIG. 1a shows the back of a typical v-mount battery 100. The v-mount battery 100 comprises a v-lock insert 102 and a female electrical connection 104 protruding out of the battery body 106.

FIG. 2a shows the back a typical gold-mount battery 200. The gold-mount battery 200 comprises locking pins 212 and a female electrical connection 214 protruding out of the battery body 216.

During ordinary use, such batteries are mounted onto a battery plate. Battery plates can be attached to an electronic device, acting as an intermediary between the battery and the electronic device. For example, a battery plate attached to a camera facilitates the transfer of power from the battery to the camera. Conversely, a battery plate attached to a charger facilitates the transfer of power from the charger to the battery.

FIG. 1b shows the front of a typical v-mount battery plate 150. The v-mount battery plate 150 comprises two v-mount battery receiving elements, a v-lock base 152 and a male electrical connection 154 protruding out of the battery plate body 156. The battery plate's v-lock base 152 can receive the v-mount battery's v-lock insert 102. Likewise, the battery plate's male electrical connection 154 can receive the v-mount battery's female electrical connection 104.

FIG. 2b shows the front of a typical gold-mount battery plate 250. The gold-mount battery plate 250 comprises two gold-mount battery receiving elements, pin holes 262 and a male electrical connection 264 integrated into the battery plate body 266. The battery plate's pin holes 262 can receive the gold-mount battery's locking pins 152. Likewise, the battery plate's male electrical connection 264 can receive the gold-mount battery's female electrical connection 154.

The v-mount battery plate lacks the gold-mount battery receiving elements required to receive gold-mount batteries and the gold-mount battery plate lacks the v-mount battery receiving elements required to receive v-mount batteries. As evidenced, for battery plates that receive one battery at a time, existing designs can only receive one type of battery. This limitation presents several drawbacks. First, film crews that use multiple battery types must carry around at least two battery plates, adding unnecessary purchase and transportation costs. Second, switching battery types requires switching battery plates, resulting in delays during filming. What is needed is a hybrid battery plate capable of receiving both v-mount batteries and gold-mount batteries.

### SUMMARY

One aspect of the present disclosure is directed at a hybrid battery plate comprising a first-type battery receiving element movably secured within a cavity in the hybrid battery plate, a second-type battery receiving element integrated into the hybrid battery plate, and a spring element in between the first-type battery receiving element and the hybrid battery plate.

In a first configuration, the first-type battery receiving element protrudes out of the hybrid battery plate, allowing the hybrid battery plate to receive a first-type battery but not a second-type battery. In a second configuration, the first-type battery receiving element sits within the hybrid battery plate, allowing the hybrid battery plate to receive a second-type battery but not a first-type battery. The hybrid battery plate is adjusted from the first configuration into the second configuration by pushing the first-type battery receiving element into the cavity.

The hybrid battery plate powers electronic devices when a battery is received. The hybrid battery plate charges a battery when connected to an external power source. The first-type battery may be a v-mount battery and the second-type battery may be a gold-mount battery.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1a shows the back of a typical v-mount battery, as seen in the prior art.

FIG. 1b shows the front of a typical v-mount battery plate, as seen in the prior art.

FIG. 2a shows the back of a typical gold-mount battery, as seen in the prior art.

FIG. 2b shows the front of a typical gold-mount battery plate, as seen in the prior art.

FIG. 3 shows the front of a hybrid battery plate, according to an embodiment.

FIG. 4a shows a cross-section of a hybrid battery plate, in a first configuration, according to an embodiment.

FIG. 4b shows a cross-section of a hybrid battery plate, in a second configuration, according to an embodiment.

FIG. 5a shows a side view of the attachment of a gold-mount battery to the hybrid battery plate in the first configuration, according to an embodiment.

FIG. 5b shows a side view of the attachment of a gold-mount battery to the hybrid battery plate in the second configuration, according to an embodiment.

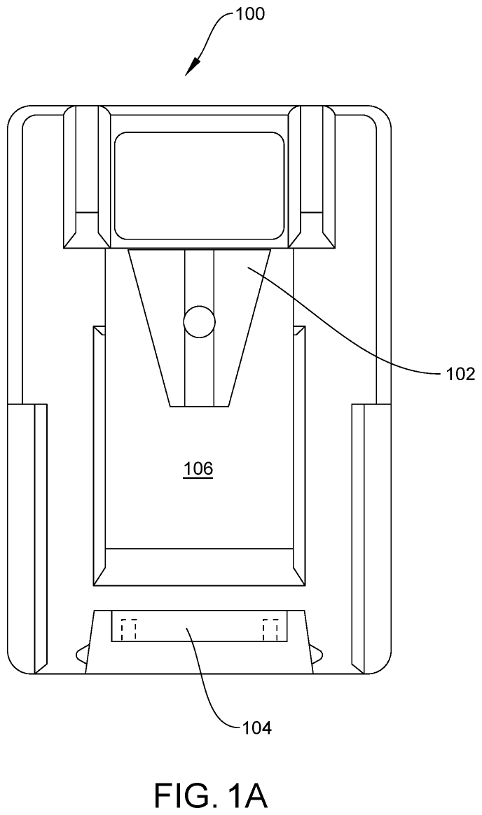

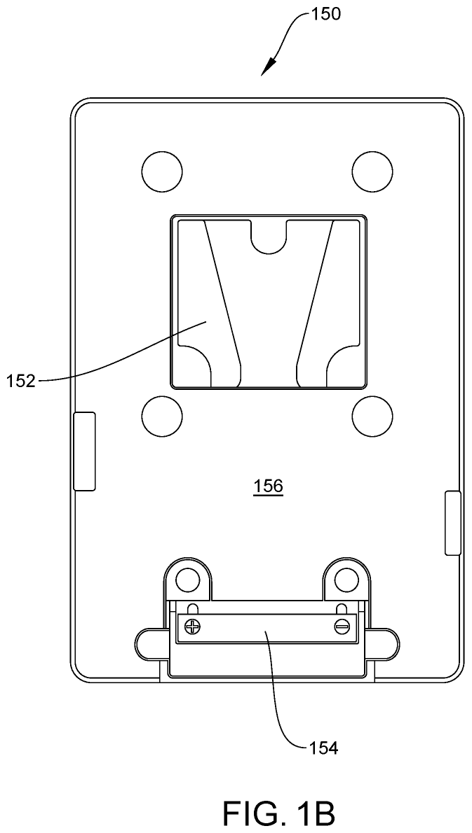

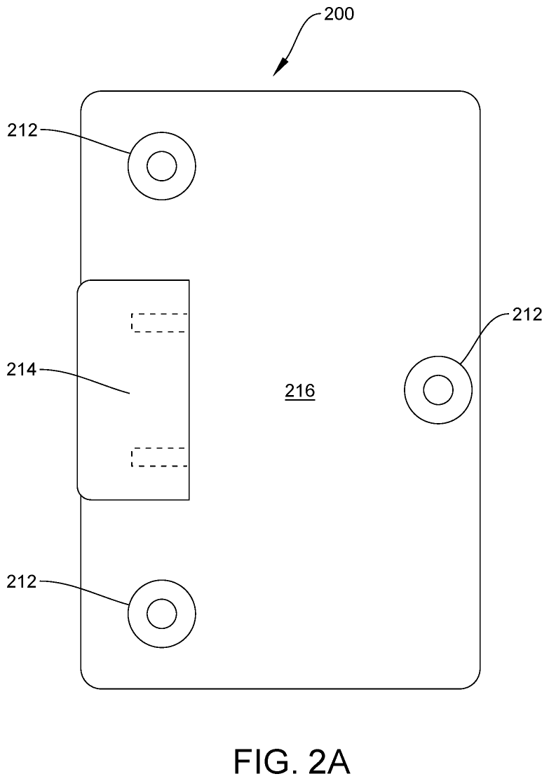

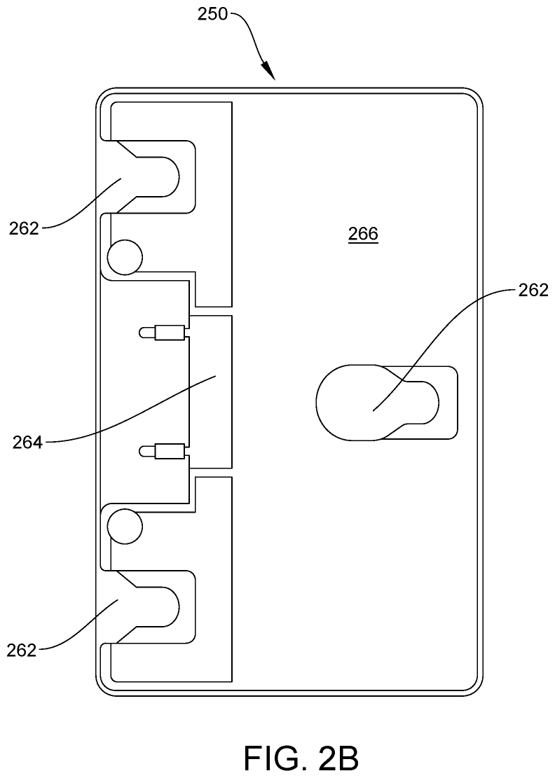

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of a hybrid battery plate for v-mount batteries and gold-mount batteries, it will be recognized by those of ordinary skill that the present disclosure is not so limited. In fact, the principles of the present disclosure described herein may be readily applied to battery holders, battery chargers, and other battery-adjacent electronics.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

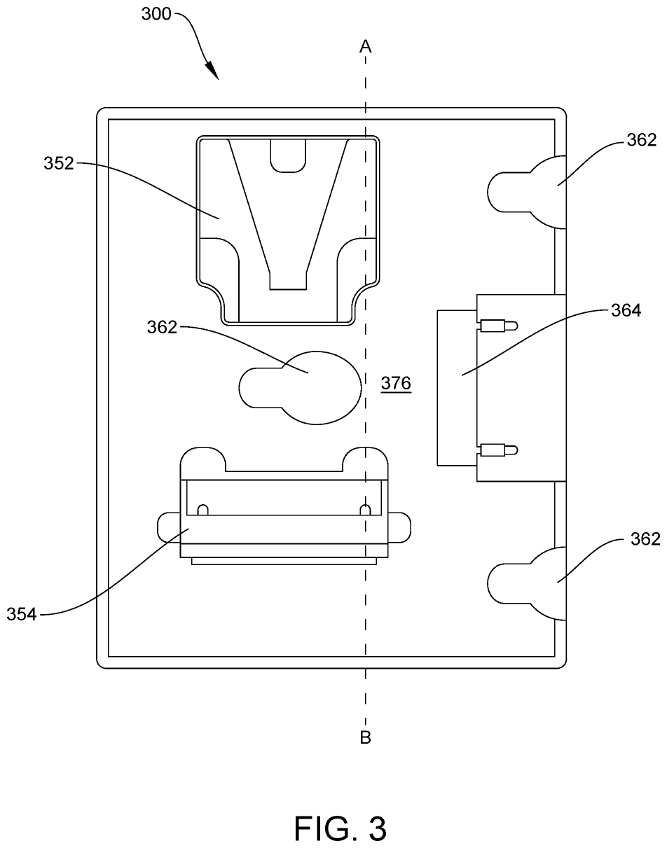

FIG. 3 shows the front of a hybrid battery plate 300, according to an embodiment. The hybrid battery plate 300 comprises v-mount battery receiving elements and gold-mount receiving elements. In a preferred embodiment, the v-mount battery receiving elements comprise a v-lock base 352 and a male electrical connection 354 protruding out of the battery plate body 376. The gold-mount receiving elements comprise pin holes 362 and a male electrical connection 364 integrated into the battery plate body 376.

Alternatively, the hybrid battery plate 300 comprises first-type battery receiving elements and second-type battery receiving elements. First-type battery receiving elements may comprise any battery plate component that can receive, partially or entirely, a first-type battery. Second-type battery receiving elements may comprise any battery plate component that can receive, partially or entirely, a second-type battery.

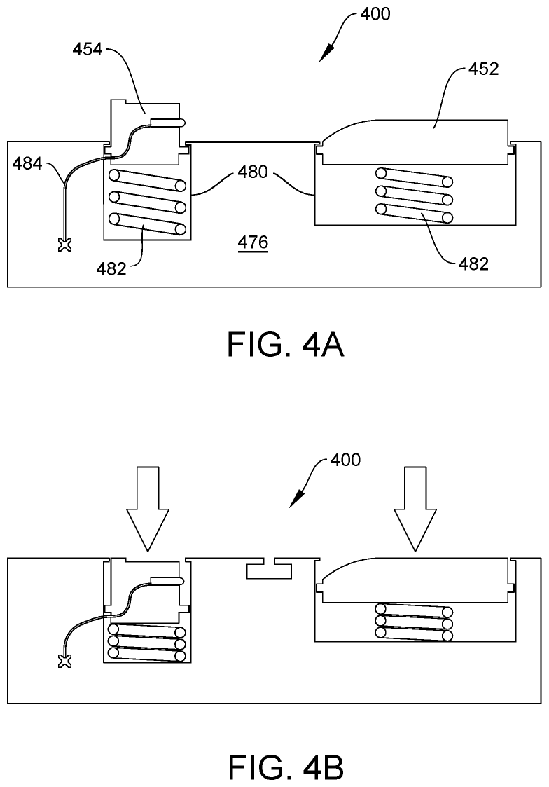

FIG. 4a shows a cross-sectional view of the hybrid battery plate 300, taken along line A-B. According to an embodiment, the hybrid battery plate 400 further comprises cavities 480 in the battery plate body 476. The v-lock base 452 and the male electrical connection 454 are movably secured within the cavities 480. Alternatively, the v-mount battery receiving elements are movably secured to the battery plate body 476 using mechanisms that allow the v-mount battery receiving elements to slide or pivot relative to the battery plate body 476.

In a first configuration of the hybrid battery plate 400, the v-mount battery receiving elements protrude out of the cavities 480 and are capable of receiving a v-mount battery.

According to an embodiment, the hybrid battery plate 400 further comprises spring elements 482 in between the v-mount battery receiving elements and the battery plate body 476. The spring elements 482 may use any known method of applying an outwards force, such as springs, to maintain the v-mount battery receiving elements in the first configuration. Alternatively, one-part or two-part fastening mechanisms, such as magnets, may be used to maintain the v-mount battery receiving elements in the first configuration.

According to an embodiment, the hybrid battery plate 400 further comprises wiring 848 to facilitate the transfer of power among the hybrid battery plate 400, a battery, and an attached electronic device.

FIG. 4b shows a cross-sectional view of the hybrid battery plate 300, taken along line A-B. In a second configuration of the hybrid battery plate 400, the v-mount receiving elements sit within the cavities 480 and are not capable of receiving a v-mount battery. The hybrid battery plate 400 is adjustable from the first configuration to the second configuration by pushing the v-mount battery receiving elements into the cavities 480.

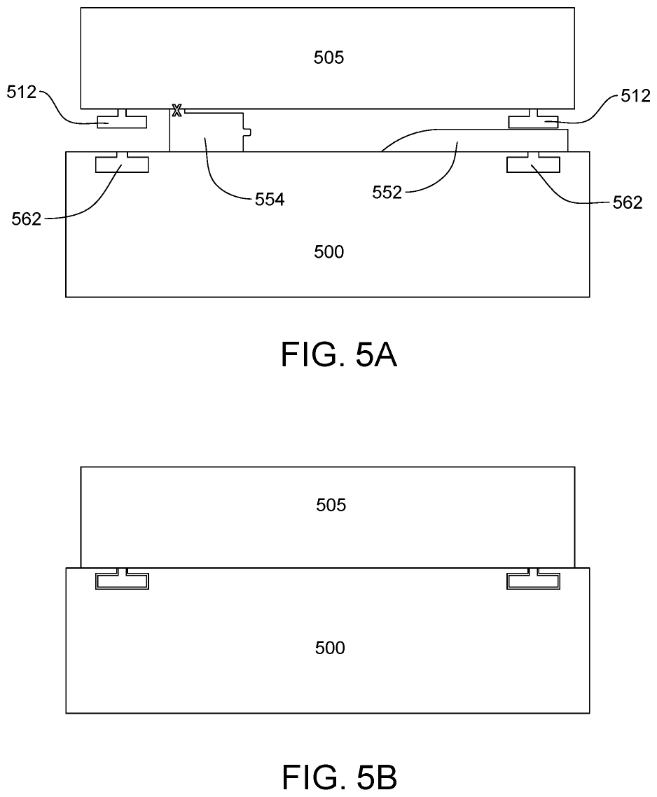

FIG. 5a shows a side view of a gold-mount battery 505 being attached to the hybrid battery plate 500, according to an embodiment. For clarity, the female electrical connection of the gold-mount battery and the male electrical connection of the hybrid battery plate are not illustrated.

The hybrid battery plate 500 is in the first configuration such that the v-mount receiving elements 552 554 protrude out of the hybrid battery plate 500. The hybrid battery plate 500 cannot receive the gold-mount battery because the locking pins 512 cannot be inserted into the pin holes 562.

FIG. 5b shows a side view of a gold-mount battery 505 being attached to the hybrid battery plate 500, according to an embodiment. For clarity, the female electrical connection of the gold-mount battery and the male electrical connection of the hybrid battery plate are not illustrated.

The hybrid battery plate 500 is in the second configuration such that the v-mount receiving elements 552 554 sit within the hybrid battery plate 500. The hybrid battery plate 500 can receive the gold-mount battery because the v-mount receiving elements no longer prevent the insertion of the locking pins 512 into the pin holes 562.

I claim:

1. A battery plate, wherein,
the battery plate receives a first-type battery in a first configuration;
the battery plate receives a second-type battery in a second configuration; and
the battery plate cannot concurrently receive the first-type battery and the second-type battery.

2. The battery plate of claim 1, comprising a first-type battery receiving element movably secured to a body of the battery plate.

3. The battery plate of claim 2, further comprising a second-type battery receiving element.

4. The battery plate of claim 3, wherein the second-type battery receiving element is integrated into the body of the battery plate.

5. The battery plate of claim 2, wherein the first-type battery receiving element is movably secured within a cavity in the body the battery plate.

6. The battery plate of claim 5, wherein the first-type battery receiving element protrudes out of the cavity in the first configuration.

7. The battery plate of claim 6, wherein the first-type battery receiving element sits within the cavity in the second configuration.

8. The battery plate of claim 7, wherein the battery plate is adjustable from the first configuration into the second configuration by pushing the first-type battery receiving element into the cavity.

9. The battery plate of claim 7, wherein a spring element in between the battery plate and the first-type battery receiving element maintains the battery plate in the first configuration.

10. The battery plate of claim 7, further comprising a second-type battery receiving element.

11. The battery plate of claim 7, wherein,
the first-type battery is a v-mount battery;
the first-type battery receiving element is a v-mount battery receiving element;
the second-type battery is a gold-mount battery; and
the second-type battery receiving element is a gold-mount battery receiving element.

12. The battery plate of claim 7, wherein the battery plate charges one of the first-type battery and the second-type battery when connected to an external power source or charger.

13. A battery plate configured to non-concurrently receive a v-mount battery and a gold-mount battery.

14. The battery plate of claim 13, comprising a v-mount battery receiving element movably secured within a cavity in a body of the battery plate.

15. The battery plate of claim 14, further comprising a gold-mount battery receiving element integrated into the body of the battery plate.

16. The battery plate of claim 14, wherein,
the v-mount battery receiving element protrudes out of the cavity in a first configuration; and
the v-mount battery receiving element sits within the cavity in a second configuration.

17. The battery plate of claim 16, wherein the battery plate is adjustable from the first configuration to the second configuration by pushing the v-mount battery receiving element into the cavity.

18. The battery plate of claim 17, wherein a spring element in between the battery plate and the v-mount battery receiving element maintains the battery plate in the first configuration.

19. The battery plate of claim 16, wherein the battery plate powers attached electronic devices when one of the v-mount battery and the gold-mount battery is received.

20. The battery plate of claim 16, wherein the battery plate charges one of the v-mount battery and the gold-mount battery when connected to an external power source or charger.
